(19) United States
(12) Patent Application Publication
(10) Pub. No.: US 2024/0112597 A1
(43) Pub. Date: Apr. 4, 2024

(54) APPARATUS AND METHOD FOR PROVIDING CUSTOMIZED INTERACTION BASED ON DISABILITY INFORMATION

(71) Applicant: DOT INCORPORATION, Seoul (KR)

(72) Inventors: Ji Ho KIM, Incheon (KR); Ju Yoon KIM, Gwangmyeong-si (KR); Hyeon Cheol PARK, Gwangmyeong-si (KR)

(21) Appl. No.: 17/994,307

(22) Filed: Nov. 26, 2022

(30) Foreign Application Priority Data
Sep. 29, 2022 (KR) 10-2022-0124071

(51) Int. Cl. G09B 21/00

(52) U.S. Cl. CPC G09B 21/004; G09B 21/006

(57) ABSTRACT

Provided are an apparatus and method for providing customized interaction based on disability information, and the method of providing customized interaction based on disability information includes obtaining disability information including a disability type and a disability degree of a user, setting at least one of a first element associated with a user input application method of a target device and a second element associated with an information output method of the target device on the basis of the disability information, obtaining a user input, which is applied to the target device by the user on the basis of the first element, and outputting information corresponding to the user input through the target device on the basis of the second element.

### CROSS REFERENCE TO RELATED APPLICATION

This application claims priority from and the benefit of Korean Patent Application No. 10-2022-0124071, filed on Sep. 29, 2022, which is hereby incorporated by reference for all purposes as if fully set forth herein.

### BACKGROUND

### Field

The disclosure relates to an apparatus and method for providing customized interaction based on disability information.

### Discussion of the Background

Due to the recent 4^{th} industrial revolution and the development of IT technology, unmanned devices (e.g., kiosks or the like), which replace conventional workers in providing various information and services, have appeared in large numbers, and the frequency of their use is increasing worldwide. However, since most of the current unmanned devices mainly are produced, disseminated, and operated towards a target of non-disabled users and users of younger age groups, it is hardly difficult for the information vulnerable users, such as disabled users and elderly users, to access and use the services provided by the current unmanned devices.

In this regard, the number of disabled people accounts for about 15% of the world's population, reaching 1 billion people worldwide. In addition, the aging population has been intensified from countries of G20, and thus, it is expected that the aged population ratio reaches about 17% of the world's population by the year of 2050. After all, in the future, the disabled people or the elderly may increase to about 3 out of 10 of the total population. In addition, considering that the adoption of unmanned devices is an inevitable trend that no one can resist due to the lack of service workers, it is expected that information inequality in information vulnerable users, such as the disabled users and the elderly users, continues to intensify and becomes a big social issue.

Meanwhile, in Korea, reflecting these trends, revised bills of the Framework Act on National Informatization and the Discrimination Disability Act have been recently approved. The main contents of the revised bills are that disabled users are allowed to access and use services on an equal basis with non-disabled users. Thus, it is evaluated that the discrimination against the disabled users be abolished in the use of unmanned terminals.

However, as the automation level of unmanned devices gradually increases and the range of services that can be replaced by the unmanned devices expands, the unmanned devices tend to be actively introduced in stores and public places. In contrast to the above tendency, it is still hardly difficult for the information vulnerable users to access to the unmanned devices, and the unmanned devices still continue to be a barrier to the aforementioned information vulnerable users as the unmanned devices are operated on the premise that the users are well-acquainted with the usage of the unmanned device.

Therefore, there has been a need for an improved unmanned device in which elements related to a user interface and user experience can be provided in a responsive or customized manner in consideration of the usage environment of the unmanned devices and the user characteristics, so that most users, including the information vulnerable users, can use the unmanned devices without difficulty.

The background art of the disclosure is disclosed in Korean Patent Registration No. 10-1480326.

### SUMMARY

The disclosure is directed to providing a customized interaction providing apparatus and method based on disability information, capable of improving use convenience of a disabled user by applying a user input application method and an information output method of a device, with which a user interacts, in a customized manner on the basis of disability information of the user.

However, the technical problems to be achieved by embodiments of the disclosure are not limited to the technical problems as described above, and other technical problems may exist.

According to an aspect of an embodiment, there is provided a customized interaction providing method based on disability information, the method including obtaining disability information including at least one of a disability type or a disability degree of a user, setting at least one of a first element associated with a user input application method of a target device or a second element associated with an information output method of the target device on the basis of the disability information, obtaining a user input, which is applied to the target device by the user on the basis of the first element, and outputting information corresponding to the user input through the target device on the basis of the second element.

In an embodiment, the first element may include at least one of a touch-based input element, a voice-based input element, or an auxiliary means input element.

In an embodiment, the second element may include at least one of a visual output element, an auditory output element, or a braille-based output element.

In an embodiment, the disability type may include at least one of a visual impairment type, a hearing-impaired type, or a physical disability type.

In an embodiment, the braille-based output element may include a braille cell module provided in the target device.

In an embodiment, the customized interaction providing method based on disability information may include controlling the target device to allow the user to access the braille cell module when the user is determined as being a blind user on the basis of the disability information.

In an embodiment, in the obtaining of the disability information, the disability information may be estimated by receiving the disability information from a user terminal of the user, determining the disability information on the basis of the user input applied to the target device, or analyzing image data obtained by capturing an image of the user.

In an embodiment, when the disability type of the user is the hearing-impaired type, the outputting of the information corresponding to the user input may include controlling a method of displaying sign language image information including information corresponding to the user input on the basis of user status information, which includes at least one of position information, body information, or gaze information which are associated with the user.

In an embodiment, when the disability type of the user is the physical disability type, the obtaining of the user input may include controlling a position and a driving method of the auxiliary means input element on the basis of user status information including at least one of position information, body information, or gaze information which are associated with the user.

According to an aspect of another embodiment, there is provided an apparatus for providing customized interaction based on disability information, the apparatus including a user identification unit configured to obtain disability information including at least one of a disability type or a disability degree of a user, a component setting unit configured to set at least one of a first element associated with a user input application method of a target device or a second element associated with an information output method of the target device on the basis of the disability information, an input unit configured to obtain a user input, which is applied to the target device by the user on the basis of the first element, and an output unit configured to output information corresponding to the user input through the target device on the basis of the second element.

In an embodiment, the apparatus for providing customized interaction based on disability information may include a module control unit configured to control the target device to allow the user to access the braille cell module when the user is determined as being a blind user on the basis of the disability information.

In an embodiment, the user identification unit may estimate the disability information by receiving the disability information from a user terminal of the user, determining the disability information on the basis of the user input applied to the target device, or analyzing image data obtained by capturing an image of the user.

In an embodiment, when the disability type of the user is the hearing-impaired type, the output unit may control a method of displaying sign language image information including information corresponding to the user input on the basis of user status information, which includes at least one of position information, body information, or gaze information which are associated with the user.

In an embodiment, when the disability type of the user is the physical disability type, the input unit may control a position and a driving method of the auxiliary means input element on the basis of user status information including at least one of position information, body information, or gaze information which are associated with the user.

According to an aspect of another embodiment, there is provided a customized information system based on disability information, the information system including an interaction providing apparatus configured to obtain disability information including a disability type and a disability degree of a user, set at least one of a first element associated with a user input application method of a target device or a second element associated with an information output method of the target device on the basis of the disability information, and control a target device on the basis of the first element and the second element, and the target device configured to receive a user input of the user on the basis of the first element, and output information corresponding to the user input on the basis of the second element.

In an embodiment, the first element comprises at least one of a touch-based input element, a voice-based input element, or an auxiliary means input element, the second element comprises at least one of a visual output element, an auditory output element, or a braille-based output element, and the disability type comprises at least one of a visual impairment type, a hearing-impaired type, or a physical disability type.

In an embodiment, the braille-based output element comprises a braille cell module provided in the target device, and the interaction providing apparatus further comprises a module control unit configured to control the target device to allow the user to access the braille cell module when the user is determined as being a blind user on the basis of on the disability information.

In an embodiment, the interaction providing apparatus estimates the disability information by receiving the disability information from the user terminal of the user, determining the disability information on the basis of the user input applied to the target device, or analyzing image data obtained by capturing an image of the user.

In an embodiment, when the disability type of the user is the hearing-impaired type, the interaction providing apparatus controls a method of displaying sign language image information comprising information corresponding to the user input on the basis of user status information, which comprises at least one of position information, body information, or gaze information which are associated with the user.

In an embodiment, when the disability type of the user is the physical disability type, the interaction providing apparatus controls a position and a driving method of the auxiliary means input element on the basis of user status information comprising at least one of position information, body information, or gaze information which are associated with the user.

The above-described means for solving problems are merely illustrative, and should not be construed as limiting the disclosure. In addition to the exemplary embodiments described above, additional embodiments may exist in the drawings and detailed description of disclosure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic configuration view of a customized information system based on disability information according to an embodiment of the disclosure;

FIG. 2 is a conceptual view for describing a process of estimating the disability information using image data obtained by capturing an image of a user;

FIG. 3 is a conceptual view for describing a process of selectively allowing the user to access a braille cell module;

FIG. 4 is a schematic configuration view of a apparatus for providing customized interaction based on disability information according to an embodiment of the disclosure; and

FIG. 5 is an operation flowchart illustrating a customized interaction providing method based on disability information according to an embodiment of the disclosure.

### DETAILED DESCRIPTION

Hereinafter, embodiments of the disclosure will be described in detail with references to the accompanying drawings in such a manner that those of ordinary skill in the art to which the disclosure pertains can easily implement them. However, the disclosure may be implemented in several different forms and is not limited to the embodiments described herein. In an embodiment, in order to clearly explain the disclosure in the drawings, portions irrelevant to the descriptions are omitted, and similar reference numerals are attached to similar portions throughout the specification.

Throughout this specification, when a part is “connected” with another part, it is not only “directly connected” but also “electrically connected,” or “indirectly connected” with another element interposed therebetween.

Throughout this specification, when it is said that a member is located “on”, “on an upper portion of”, “on a top of”, “under”, “on a lower portion of”, and “on a bottom of” another member, this means that a member is located on the other member. It includes not only the case where they are in contact, but also the case where another member exists between two members.

Throughout this specification, when a portion or a part “includes” a component or an element, it means that other components or elements may be further included, rather than excluding other components, unless otherwise stated.

The disclosure relates to a customized interaction providing apparatus and method based on disability information.

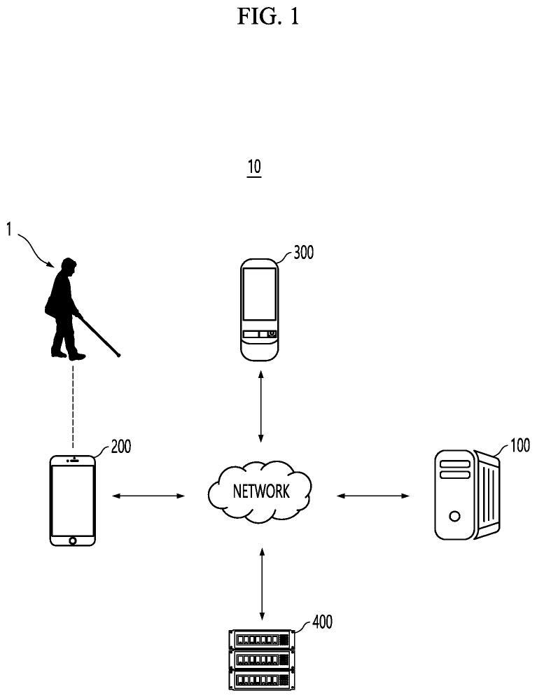

FIG. 1 is a schematic configuration view of a customized information system based on disability information according to an embodiment of the disclosure.

Referring to FIG. 1, a customized information system 10 based on disability information according to an embodiment of the disclosure may include a customized interaction providing apparatus 100 based on disability information (hereinafter, referred to as an interaction providing apparatus 100) according to an embodiment of the disclosure, an information terminal 300, an user terminal 200, and an external server 400.

The interaction providing apparatus 100, the information terminal 300, the user terminal 200, and the external server 400 may communicate with one another via a network 20. The network 20 refers to a connection structure which enables information to be exchanged between each node, such as terminals and servers. Examples of the network 20 may include a 3rd Generation Partnership Project (3GPP) network, Long Term Evolution (LTE) network, 5G network, World Interoperability for Microwave Access (WIMAX) network, Internet, Local Area Network (LAN), Wireless Local Area Network (Wireless LAN), Wide Area Network (WAN), Personal Area Network (PAN), a wifi network, a Bluetooth network, a satellite broadcasting network, an analog broadcasting network, a Digital Multimedia Broadcasting (DMB) network, or the like. However, the network 20 is not limited to those examples described above.

In an embodiment, although not shown in the figures, the customized information system 10 may include an auxiliary terminal (not shown) carried by a disabled user or the like. The auxiliary terminal (not shown) may be, e.g., a device capable of outputting braille-based information for a visually impaired user (e.g., a blind person or the like). In an example embodiment, the device capable of outputting braille-based information may include a braille watch, a braille pad, or the like. which has a display including a plurality of braille protrusion members. However, the auxiliary terminal is not limited to the device for the visually impaired user. Thus, the auxiliary terminal (not shown) herein may further include a wide range of various devices that can be used to assist various information vulnerable users such as disabled users and elderly users. For example, the auxiliary terminal (not shown) may be a concept including various devices for assisting the user's vision, mobility, hearing, cognitive ability, and the like, such as a hearing aid, an interpreter, a cane, an electric wheelchair, and the like. In an embodiment, according to the implementation of the disclosure, a user interacting with the information terminal 300 may have (possess) only the user terminal 200 without a separate auxiliary terminal (not shown) or have (possess) both the auxiliary terminal (not shown) and the user terminal 200.

The user terminal 200 may include any type of wireless communication device, e.g., a smartphone, a smart pad, a tablet PC, and the like, and terminals for PCS (Personal Communication System), GSM (Global System for Mobile communication), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet).

For reference, in relation to the embodiment of the disclosure, a ‘target space’ mainly means a multi-use facility or space used by a large number of people, such as subway stations, public transportation platforms, train stations, airports, shopping malls, department stores, parks, movie theaters, schools, stadiums, gyms, public institutions, and the like. However, the target space is not limited to those described above.

In an embodiment, the information terminal 300 may be installed in the target space for the purpose of providing the user with route information for destinations, such as major facilities (toilets, elevators, escalators, or the like), stores (shops), and specific locations, or the like in the target space. However, the information terminal 300 is not limited to those described above, and may also be installed for the purpose of providing the user (passerby) with information on the target space or various types of information that is not limited to the target space.

In an embodiment, in the description of the embodiment of the disclosure, the information terminal 300 may be a concept that broadly includes an unmanned device, a kiosk, a digital signage, and the like. In an embodiment, as will be described in detail below, the information terminal 300 disclosed herein may be designed to provide a user interface (UI)/user experience (UX) in a customized manner according to user information, in consideration of information accessibility of the users corresponding to the information vulnerable users, such as the disabled user, the elderly user, and the like.

In an embodiment, in the description of the embodiment of the disclosure, the interaction providing apparatus 100 may be configured to mount in the information terminal 300, and may be a subcomponent of the information terminal 300 for performing an operation of controlling (changing) elements associated with the UI/UX of the information terminal 300. In another example, according to the embodiment of the disclosure, the interaction providing apparatus 100 may be a device that is provided separately from the information terminal 300 and configured to perform an operation of controlling (changing) the elements associated with the UI/UX of the information terminal 300.

In the description of the embodiment of the disclosure, the external server 400 may be configured to retain user information of each user in advance and provide necessary user information to the interaction providing apparatus 100. In an embodiment, the external server 400 may have a function of providing spatial information (e.g., locations of major facilities, map information, or the like) on the target space, in which the information terminal 300 with which the user interacts is located, to the interaction providing apparatus 100. In an example embodiment, the external server 400 may retain the user information in advance in a manner of receiving user information of a user who has (possesses) the corresponding user terminal 200 from the user terminal 200 in advance and storing the user information as user information for the corresponding user.

In an embodiment, according to an embodiment of the disclosure, the user information that is secured in advance by the external server 400 and provided to the interaction providing apparatus 100 may include personal information such as a user's name, age, gender, address, and contact information, as well as disability information such as a disability type and a disability grade (level) in the case of a disabled user.

Hereinafter, a function (operation) will be described in detail, in which the interaction providing apparatus 100 controls a user input application method and/or an information output method, which is applied to the target device with which the user interacts, such as the information terminal 300, in a customized manner using the disability information of the user. In other words, the interaction providing apparatus 100 may set the elements associated with the UI/UX of the target device in a customized manner using the disability information of the user, so that the disabled user can easily interact with the elements.

The interaction providing apparatus 100 may obtain disability information including a disability type and a disability degree of the user. In this regard, in the description of the embodiment of the disclosure, the disability type of the user may include at least one of a visual impairment type, a hearing-impaired type, or a physical disability type. In an embodiment, in the description of the embodiment of the disclosure, the disability degree of the user may include information indicating a degree of deterioration in physical ability corresponding to the disability type of the user, and may refer to, for example, disability degree information according to Criteria for Judgment by Disability Type, but the disability degree of the user is not limited to the disability degree information. In an embodiment, according to an embodiment of the disclosure, when a particular user is a user having a combination of different types of disabilities, the disability information on the corresponding user may be obtained in the form of complex information including a plurality of disability types and a disability degree according to each of the disability types.

In this regard, according to an embodiment of the disclosure, the interaction providing apparatus 100 may receive the disability information from the user terminal 200 of the user. In another example, the interaction providing apparatus 100 may determine the disability information of the user currently interacting with the target device on the basis of a user input applied to the target device such as the information terminal 300.

In still another example, the interaction providing apparatus 100 may estimate the disability information by analyzing image data obtained by capturing an image of the corresponding user. In an example embodiment, the interaction providing apparatus 100 may obtain image data captured by an infrastructure (not shown) such as a closed circuit television (CCTV) provided in a space in which the user interacts (more particularly, an act of manipulating the target device by the user, an act of providing information that the user wants to obtain through the target device, or the like) with the target device, or may obtain image data, which is captured by a camera module (not shown) provided in the information terminal 300 in a process in which a particular user accesses the information terminal 300 or manipulates the information terminal 300 using a peripheral part of the information terminal 300, from the information terminal 300.

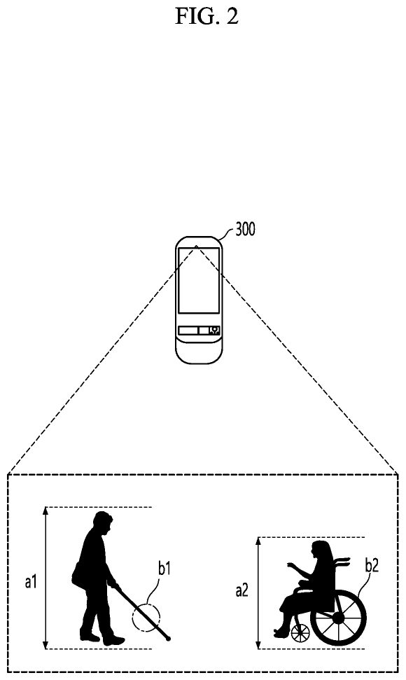

FIG. 2 is a conceptual view for describing a process of estimating the disability information using image data obtained by capturing an image of a user.

Referring to FIG. 2, the interaction providing apparatus 100 may operate to estimate the disability information from at least one of appearance characteristics, behavior characteristics, or object characteristics of the user reflected in the image data.

According to an embodiment of the disclosure, the appearance characteristics of the user may include the height, appearance, physique, and the like of the user. In an embodiment, the behavior characteristics of the user may include the gait, a body movement, and the like of the user. In an embodiment, the object characteristics of the user may include identification of a tool, the user terminal 200, an auxiliary terminal (not shown), clothes, a walking assistance aids, a wheelchair, and the like which the user possess.

In an example embodiment, referring to FIG. 2, the interaction providing apparatus 100 may obtain height information a1 of a first user (the user shown on a left side of FIG. 2) reflected in the image data, object information b1 indicating that the user is holding a cane, height information a2 of a second user (the user shown on a right side of FIG. 2) reflected in the image data, and object information b2 indicating that the user is riding in a wheelchair, and may use the pieces of height information a1 and a2 and the pieces of object information b1 and b2 to estimate the existence of disability, a disability type, a disability degree, and the like of each user.

In another example, in the case of a visually impaired user who wears “sunglasses” and walks while carrying a “white cane”, the interaction providing apparatus 100 may identify the sunglasses, the white cane, and the like as the object characteristics of the corresponding user from the image in which the corresponding user appears, and may recognize that the corresponding user is a visually impaired user in response to the identification. Similarly, the interaction providing apparatus 100 may recognize that the user is a visually impaired user by identifying characteristics in which the user walks while striking guidance blocks on the ground with the white cane as the behavior characteristics. In this regard, the interaction providing apparatus 100 may have a pre-trained artificial intelligence model (e.g., a deep learning algorithm that detects an appearance object through semantic segmentation or the like) for detecting the appearance characteristics, the behavior characteristics, the object characteristics, and the like from the received image.

In summary, the disability information necessary to change the elements associated with the UI/UX provided through the information terminal 300 into customized settings suitable for the user may broadly include information obtained in advance through the user terminal 200, the external server 400, or the like for the corresponding user, or information analyzed in real time by analyzing the image data obtained by capturing an image of the user using the information terminal 300.

In an embodiment, when the disability information of the user is obtained, on the basis of the obtained disability information, the interaction providing apparatus 100 may set at least one of a first element associated with the user input application method of the target device, such as the information terminal 300, the user terminal 200, or the like, or a second element associated with the information output method of the target device.

In the description of the embodiment of the disclosure, the first element associated with the user input application method of the target device may include at least one of a touch-based input element, a voice-based input element, or an auxiliary means input element, and the second element associated with the information output method for the user may include at least one of a visual output element, an auditory output element, or a braille-based output element.

In other words, the interaction providing apparatus 100 may adjust the first element and the second element, which are elements associated with the UI/UX of the target device, in a customized manner by considering the user's reduced physical ability on the basis of the disability information including the disability type and disability degree of the user, so that the corresponding user can interact with the target device.

More particularly, the setting of the first element and the second element of the information terminal 300 in a customized manner may include providing a customized UI/UX for the user by changing the conventional information input/output method, in which the usability of the disabled user or the like is not taken into consideration, for the information terminal 300 by considering the information access ability of the user, such as the user's vision, mobility, hearing, cognitive ability, and the like on the basis of the disability type of the user, so that pieces of predefined information can be provided (transmitted) through the target device such as the information terminal 300 in a manner that the user can conveniently manipulate and easily understand.

That is, the term “customized setting” in the disclosure may include a conversion rule for converting at least some of the elements related to the conventional UI/UX of the information terminal 300, so that the information terminal 300 can provide information (contents), which is the same as that previously provided for non-disabled users and the like, in a form in which the information vulnerable users can conveniently manipulate and easily understand.

When the user for the disability information is a visually impaired user, the interaction providing apparatus 100 may change the first element of the target device so that the target device is controlled on the basis of at least one control input application method from among a braille input method, a voice input method, or an intuitive touch input method.

In an embodiment, when the user for the disability information is a visually impaired user, the interaction providing apparatus 100 may change the second element of the target device into a customized setting in which predetermined information is displayed on the basis of at least one information output method from among a voice output method or a braille output method.

More particularly, for a customized setting including the braille input method as the control input application method and the braille output method as the information output method, the interaction providing apparatus 100 may control the information terminal 300 so that the user can access a braille cell module 310 provided in the information terminal 300.

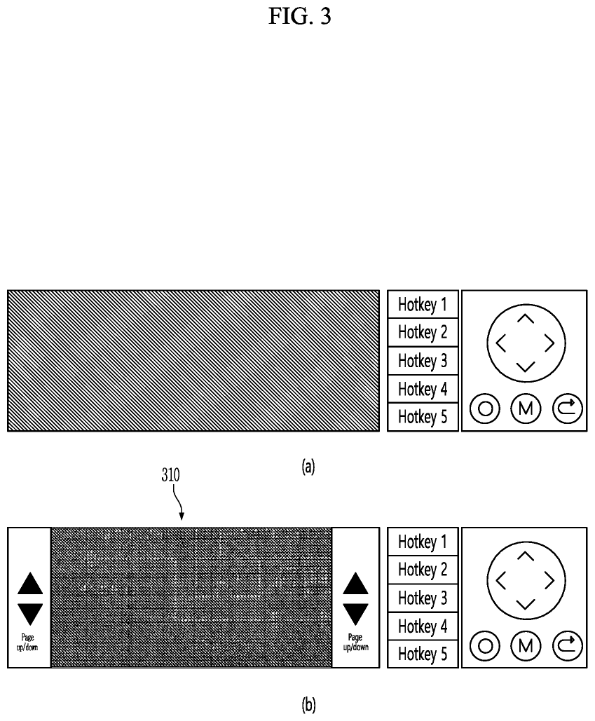

FIG. 3 is a conceptual view for describing a process of selectively allowing the user to access the braille cell module.

Referring to FIG. 3, the braille cell module 310 may be placed in a locked state (the state shown in FIG. 3A) by a predefined locker (e.g., a cover member that restricts an access to the braille cell module 310 in a closed state, or the like) so that a plurality of braille protrusions provided in the braille cell module 310 are prevented from being contaminated and damaged by preventing the braille cell module 310 from being used by users other than the visually impaired user, and the locked state may be selectively released (the state shown in FIG. 3B) only when the visually impaired user intends to use the information terminal 300. Accordingly, when it is determined that the corresponding user corresponds to the visually impaired user on the basis of the disability information of the corresponding user, the interaction providing apparatus 100 may release the locker of the braille cell module 310.

For example, when it is determined that the visually impaired user is located away from the information terminal 300 by a distance within a preset distance range on the basis of position information of the user, or it is determined that an expected arrival time of the user to the information terminal 300 calculated on the basis of the position information of the user is within a preset time range, the interaction providing apparatus 100 may control the information terminal 300 to release the above-described locker.

In other words, when the user is determined as being a blind user on the basis of the disability information of the user, the interaction providing apparatus 100 may control the target device to allow the corresponding user to access the braille cell module 310.

In an embodiment, in relation to the intuitive touch input method, the interaction providing apparatus 100 may receive a control input related to entering (selecting) and moving to a menu through a touch display provided in the information terminal 300 on the basis of a menu tree that is preset for the information provided by the information terminal 300, and here, the interaction providing apparatus 100 may receive the control input of the user by utilizing the entire area of the touch display instead of receiving the control input on the basis of buttons, icons, and the like that are locally displayed on the touch display.

In an example embodiment, the interaction providing apparatus 100 may apply a customized setting in such a configuration that the user can enter (select), move to, or the like the menu provided in the information terminal 300 by a simplified touch control method, which can be performed even by the visually impaired user with sufficient ease and convenience and includes a control input for touching at least a portion of an inner area of the touch display once or more, a control input for dragging (sliding) at least a portion of the inner area of the touch display, and the like.

In an embodiment, in this regard, the interaction providing apparatus 100 may set up various manipulation methods for the information terminal 300 in a customized manner on the basis of the menu tree preset according to the information provided by the information terminal 300. For example, the manipulation methods may include a manipulation of the information terminal 300 performed in accordance with the number of touches onto the touch display, a manipulation of the information terminal performed in match with a dragging (sliding) direction (e.g., an up-down direction, a horizontal direction, a diagonal direction between the upper left and lower right corners, a diagonal direction between the upper right and lower left corners, or the like) on the touch display, and the like.

In an embodiment, the interaction providing apparatus 100 may guide the user with specific details of the intuitive touch input method set before the user starts to interact with the information terminal 300. In an example embodiment, the interaction providing apparatus 100 may control the information terminal 300 to provide descriptions for the intuitive touch input, which is set correspondently to the visually impaired user in the information terminal 300, through voice guidance.

In an embodiment, in relation to the voice input method, the interaction providing apparatus 100 may apply a customized setting for converting a content input method for a text-type entry item into the voice input method to the information terminal 300, so that text information (e.g., contents of items to be entered by typing on the screen provided to non-disabled users, or the like) requested for input while the visually impaired user manipulates the information terminal 300 is received by the interaction providing apparatus 100 through a voice input by the visually impaired user.

In an example embodiment, when it is determined that the user has entered an item (or menu) into which text information is requested to input, the interaction providing apparatus 100 may activate a voice recognition module (e.g., a microphone or the like) of the information terminal 300, and may output a signal requesting utterance through voice. When the user's voice is applied, the input to the corresponding entry item may be processed by extracting text information corresponding to the corresponding voice through the voice recognition module.

In an embodiment, the interaction providing apparatus 100 may apply, to the information terminal 300, a customized setting including a function to enable manipulations such as entering (selecting), moving to, or the like the menu provided by the information terminal 300 through the voice control input.

In an embodiment, in relation to the voice output method, the interaction providing apparatus 100 may apply a customized setting to the information terminal 300 in such a configuration in which menu information related to the information provided by the information terminal 300, visual information displayed on a screen in a predetermined situation, and the like are converted into voice and the corresponding voice is provided. For example, in response to the user's entry into the menu, the interaction providing apparatus 100 may provide a list of menus that the user can select or a list of menu-related control manipulations to the user by arranging the list by the voice output method on the basis of the menu tree. In an embodiment, the interaction providing apparatus 100 may apply a customized setting to the information terminal 300 in a such configuration that text information or the like, which is displayed for a user other than the visually impaired user, included in the screen of the information terminal 300 is converted into voice by the voice output method and provided to the user.

In an embodiment, in relation to the braille output method, the interaction providing apparatus 100 may convert (braille translation) the menu information, the text information, or the like, which is related to the information provided from the information terminal 300, into braille text, and provide the braille text through the braille cell module 310.

In an embodiment, when the user for the disability information is a hearing-impaired user, the interaction providing apparatus 100 may change the first element and the second element of the matched information terminal 300 to a customized setting in which the matched information terminal 300 is controlled on the basis of at least one control input application method from among a touch input method or a gesture input method.

In an embodiment, when the user for the disability information is a hearing-impaired user, the interaction providing apparatus 100 may change elements associated with the UI/UX of the matched information terminal 300 to a customized setting in which the information terminal 300 displays information on the basis of at least one information output method from among an intuitive visual information output method or a gesture output method.

More particularly, in relation to the gesture input method, the interaction providing apparatus 100 may apply, to the information terminal 300, a customized setting including a function of controlling the information terminal 300 on the basis of a gesture input by activating the camera module (not shown) of the information terminal 300 and extracting the contents of the user's intention from the image secured through the camera module (not shown), so that the intention of the hearing-impaired user based on a gesture-based communication means of the hearing-impaired user, such as sign language, spoken language (oral method), or the like are identified.

In an embodiment, in relation to the intuitive visual information output method, the interaction providing apparatus 100 may apply a customized setting to the information terminal 300 in such a configuration that menu information, text information, and the like conventionally provided by the information terminal 300 in connection with information provided through the information terminal 300 are replaced with intuitive visual information, such as intuitive symbols, icons, and pictograms corresponding to the conventional menu information, text information, and the like, or displayed together with the intuitive visual information, so that even illiterate users or the like understand the information provided by the information terminal 300.

In this regard, the interaction providing apparatus 100 may include a first conversion algorithm for deriving the intuitive visual information that matches the menu information, the text information, and the like provided by the information terminal 300. For example, the first conversion algorithm may search the external server 400 in which words, vocabularies, and expressions matching the intuitive visual information, such as the symbols, the icons, the pictograms, and the like are combined with each other and stored together, and may select the intuitive visual information corresponding to the menu information, the text information, and the like provided by the information terminal 300. Then, the searched intuitive visual information may be reflected in the customized setting.

In an embodiment, in relation to the gesture output method, the interaction providing apparatus 100 may support the hearing-impaired user to understand the information provided from the information terminal 300 in such a way that a sign language (sign language), a spoken language (oral method), or the like, which matches the menu information, the text information, and the like associated with the information terminal 300, is output.

In an example embodiment, the interaction providing apparatus 100 may include a second conversion algorithm for converting the menu information, the text information, and the like associated with the information terminal 300 into the gesture output, such as a sign language, so that predetermined information is provided by the gesture output method. More particularly, the second conversion algorithm may include a tool for generating a gesture-based avatar images corresponding to the menu information, the text information, and the like associated with the information terminal 300. The interaction providing apparatus 100 may apply a customized setting to the information terminal 300 in such a configuration that the gesture-based avatar image generated from the text information, which corresponds to the menu information chosen by the user or corresponds to information requested by the user, by the second conversion algorithm is displayed on the information terminal 300.

In an embodiment, in this regard, when the disability type of the user is a hearing-impaired type, the interaction providing apparatus 100 may control a method to displaying sign language image information, which includes information corresponding to a user input applied to the target device, on the basis of user status information including at least one of position information, body information, or gaze information which are associated with the user.

More particularly, the interaction providing apparatus 100 may adjust the specification (enlargement/reduction degree) and position, in which the sign language image information or oral image information to be described below is displayed, of a display of the target device, on the basis of the user status information. For example, the interaction providing apparatus 100 may finely adjust the specification and position of the output image information on the basis of the body information, the gaze information, and the like of the user, so that the hand part of the avatar included in the sign language image information or the face part of the user included in the oral image information is located at a position corresponding to a user's eye level in the display area of the target device.

In an embodiment, according to an embodiment of the disclosure, the interaction providing apparatus 100 may control a timing, at which the sign language image information or the oral image information is displayed on the display or enlarged and displayed on the display, according to the size of the output information provided to the user through the target device.

According to an embodiment of the disclosure, the user status information (particularly, a relative position of the target device of the user, the size (arm length) of the body part, viewing angle information, and the like are broadly included) can be derived through the analysis using the image data obtained by capturing an image of the user, in the same way for the above-described disability information.

In an embodiment, according to an embodiment of the disclosure, the interaction providing apparatus 100 may operate so that the second element is determined to adopt an information transmission method familiar to the hearing-impaired user from among speech reading (oral method), in which the hearing-impaired user understands what the other person is saying by looking at the movement of the speaker's lips and facial expression, and sign language (sign language method), which is a language for transmitting the meaning by changing the shape of the hand and fingers, the direction of the palm, the position of the hand, and the movement of the hand, and the avatar generated in advance selectively outputs the sign language image information, which is expressed through hand gestures, or the oral image information, in which the face area of the pre-generated avatar is enlarged so that the user can easily recognize the change in the shape of the mouth and understand the output information, on the basis of the determined second element.

In this regard, when the user is determined as being of the hearing-impaired type, the interaction providing apparatus 100 may determine the second element to be based on the sign language method or the oral method on the basis of a user input applied to the target device. Alternatively, the interaction providing apparatus 100 may estimate the information transmission method with which the hearing-impaired user is familiar from among the sign language method and the oral method by evaluating whether the user can understand the avatar-based output image, which is output by the sign language method or the oral method according to an initial setting, through the analysis of the user's image data, or analyzing gaze information on each of local areas constituting the output image, and may set the second element in a customized manner to match the estimation result.

For example, when the user is determined as being of the hearing-impaired type, the interaction providing apparatus 100 may determine the second element as the avatar image of the sign language method according to the initial (basic) setting and output predetermined information, and when it is determined that the ratio of the gaze of the user, who views the avatar image, to the lips area of the avatar is equal to or greater than a preset threshold ratio, the interaction providing apparatus 100 may operate to re-output the same information with the avatar image of the oral method by estimating that the corresponding user is a user relatively familiar with oral method communication.

In an embodiment, according to an embodiment of the disclosure, the interaction providing apparatus 100 may apply a customized setting to the information terminal 300 in such a configuration that the visibility of various information provided from the information terminal 300 may be improved in consideration of dim-sighted users (e.g., the elderly users) having at least some residual vision. In an example embodiment, the interaction providing apparatus 100 may apply a customized setting to the information terminal 300 in such a configuration that various types of visual information displayed on the display, such as texts, images, and media, are provided by magnifying them or improving the contrast, sharpness, resolution, brightness, and the like thereof compared to the conventional ones.

In an embodiment, when the user for the disability information is a physically disabled user, the interaction providing apparatus 100 may apply a customized setting to the target device in such a configuration that the information terminal 300 is controlled on the basis of at least one control input application method from among the touch input method using a lower interface of the display, a physical key input method, or the gesture input method.

In still another example, when the disability type of the user is a physical disability type, the interaction providing apparatus 100 may control the position and driving method of the auxiliary means input element (e.g., various device manipulation means such as physical keys and a track ball) provided in the target device on the basis of the user status information including at least one of the position information, the body information, or the gaze information which are associated with the user.

More particularly, the interface, which is displayed on the touch display of the information terminal 300 in a normal state, may include a main area, a touch manipulation area, and an advertising area that are arranged in the up-down direction, so that the normal user conveniently manipulates the touch manipulation area in a standing state. Meanwhile, for the physically disabled user such as a wheelchair occupant, a customized setting may be applied to the information terminal 300 in such a configuration that the lowermost advertisement area is controlled to be removed or moved upward, and a graphic UI is changed so that the touch manipulation area is placed at the lower portion of the display.

In this regard, the position of the touch manipulation area, which is an area of the touch display of the information terminal 300 for receiving the touch input, may be appropriately determined by the customized setting set for the physically disabled user such as the wheelchair occupant, and In an embodiment, the positions of the display and the auxiliary input device may be appropriately changed by through a separate lifter, so that various usability for the physically disabled user may be given to the information terminal 300 disclosed in the disclosure in such a way that the physically disabled user can use the touch display or the auxiliary input device (e.g., physical keys). In an embodiment, the position change control of the touch manipulation area and the control of the lifter (not shown) are applied not only to the physically disabled user such as the wheelchair occupant, but also to child users with small heights, so that the information terminal 300, of course, can improve the use conveniences.

In summary, the interaction providing apparatus 100 may obtain the user input, which is applied to the target device by the user on the basis of the first element set on the basis of the disability information, and may output information corresponding to the user input through the target device on the basis of the second element.

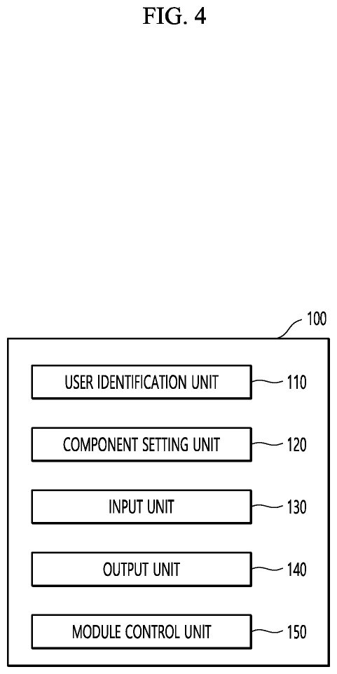

FIG. 4 is a schematic configuration view of a apparatus for providing customized interaction based on disability information according to an embodiment of the disclosure.

Referring to FIG. 4, the interaction providing apparatus 100 may include a user identification unit 110, a component setting unit 120, an input unit 130, an output unit 140, and a module control unit 150.

The user identification unit 110 may obtain disability information including a disability type and a disability degree of a user 1.

According to an embodiment of the disclosure, the user identification unit 110 may obtain the disability information in a manner of receiving the disability information from the user terminal 200 of the user 1. In another example, the user identification unit 110 may determine the disability information on the basis of a user input applied to a target device. In still another example, the user identification unit 110 may estimate the disability information of the corresponding user 1 by analyzing image data obtained by capturing an image of the user 1.

The component setting unit 120 may set at least one of a first element associated with a user input application method of the target device or a second element associated with an information output method of the target device on the basis of the disability information of the user 1.

The input unit 130 may obtain the user input, which is applied to the target device by the user 1 on the basis of the first element set by the component setting unit 120.

The output unit 140 may output information corresponding to the user input through the target device on the basis of the second element set by the component setting unit 120.

Hereinafter, the operation flow of the disclosure will be briefly described based on the details given above.

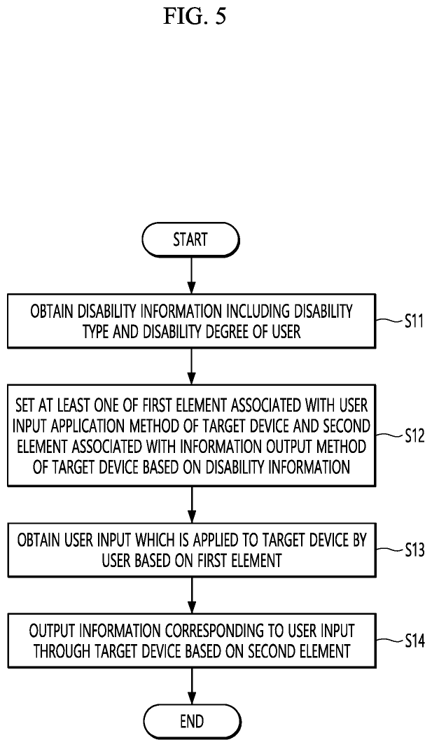

FIG. 5 is an operation flowchart illustrating a customized interaction providing method based on disability information according to an embodiment of the disclosure.

The customized interaction providing method based on disability information illustrated in FIG. 5 may be performed by the interaction providing apparatus 100 described above. Thus, although omitted below, the contents described with respect to the interaction providing apparatus 100 may be equally applied to a description of the customized interaction providing method based on disability information.

Referring to FIG. 5, in operation S11, the user identification unit 110 may obtain disability information including a disability type and a disability degree of a user 1.

Particularly, according to an embodiment of the disclosure, in operation S11, the user identification unit 110 may estimate the disability information of the user 1 by receiving the disability information of the user 1 from the user terminal 200, determining the disability information of the user 1 on the basis of a user input applied to a target device, or analyzing image data obtained by capturing an image of the user 1.

Next, in operation S12, the component setting unit 120 may set at least one of a first element associated with a user input application method of the target device or a second element associated with an information output method of the target device on the basis of the disability information obtained in operation S11.

Next, in operation S13, the input unit 130 may obtain the user input, which is applied to the target device by the user on the basis of the first element set in operation S12.

According to an embodiment of the disclosure, when it is determined that the disability type of the user 1 is a physical disability type on the basis of the disability information obtained in operation S11, in operation S13, the input unit 130 may control the position and driving method of an auxiliary means input element included in the target device on the basis of a user status information including at least one of position information, body information, or gaze information which are associated with the user 1.

In an embodiment, according to an embodiment of the disclosure, when it is determined that the disability type of the user 1 is a visual impairment type and the user 1 is a blind user on the basis of the disability information obtained in operation S11, in operation S13, the module control unit 150 may control the target device to allow the user 1 to access the braille cell module 310.

Next, in operation S14, the output unit 140 may output information corresponding to the user input, which is applied in operation S13 through the target device, on the basis of the second element set in operation S12.

According to an embodiment of the disclosure, when it is determined that the disability type of the user 1 is a hearing-impaired type on the basis of the disability information obtained in operation S11, in operation S14, the output unit 140 may control a method of displaying sign language image information including information corresponding to the user input, which is applied in operation S13, on the basis of the user status information including at least one of the position information, the body information, or the gaze information which are associated with the user 1.

In the descriptions given above, operations S11 to S14 may be further divided into additional operations or be combined into fewer operations, according to an embodiment of the disclosure. In an embodiment, some operations may be omitted if necessary, and the order between the operations may be changed.

The customized interaction providing method based on disability information according to an embodiment of the disclosure may be recorded in a computer-readable medium in the form of program instructions that can be executed by various computers. The computer-readable medium described above may include program instructions, data files, data structures, and the like which may be used alone or in combinations thereof. The program instructions recorded in the medium above described may include program instructions that are specially designed and configured only for the disclosure and program instructions that are known and available to those skilled in the art of computer software. The computer-readable recording medium may include hardware devices specially configured to store and execute program instructions. Examples of the hardware devices may include magnetic media such as a hard disk, a floppy disk and a magnetic tape (Magnetic Media), optical media such as a CD-ROM and a DVD (Optical Media), and magneto-optical media (Magneto-optical Media) such as a floppy disk (Floptical Disk), a ROM, a RAM, and flash memory. Examples of the program instructions may include high-level language codes executed by a computer using an interpreter or the like as well as machine language codes such as those generated by a compiler. The hardware devices described above may be configured to operate as one or more software modules so as to perform the operations of the disclosure, and vice versa.

In an embodiment, the customized interaction providing method based on disability information may be implemented in the form of a computer program or application that stored on a recording medium and executed by a computer.

According to the above-described problem solving means of the disclosure, it is possible to provide a customized interaction providing apparatus and method based on disability information, capable of improving use convenience of a disabled user by applying a user input application method and an information output method of a device, with which a user interacts, in a customized manner on the basis of disability information of the user.

However, the effects obtainable from the disclosure are not limited to the above-described effects, and other effects may exist.

The foregoing descriptions of the disclosure described above are illustrative of example embodiments, and those of ordinary skill in the art to which the disclosure pertains will understand that it can be easily modified into other specific forms without changing the technical spirit or essential features of the disclosure. Therefore, it should be understood that the embodiments described above are illustrative in all respects and not restrictive. For example, each component described as a single type may be implemented in a distributed manner, and likewise components described as distributed may also be implemented in a combined form.

The scope of the disclosure is indicated by the following claims rather than the above detailed description, and all changes or modifications derived from the meaning and scope of the claims and their equivalent concepts should be construed as being included in the scope of the disclosure.

1. A method of providing customized interaction based on disability information performed by an interaction providing apparatus including a user identification unit, a component setting unit, an input unit, and an output unit which are recorded in a computer-readable medium in the form of program instructions, the method comprising:
obtaining, by the user identification unit, disability information comprising at least one of a disability type or a disability degree of a user, comprising:
receiving the disability information from a user terminal through a wireless communication;
receiving a user input applied to a target device including an information terminal; or
capturing an image of the user;
determining, by the user identification unit, the disability type or disability degree of the user based on the disability information obtained, comprising:
storing the disability information from the user terminal;
storing the user input applied to the target device: or
analyzing image data obtained from the captured image of the user;
setting, by the component setting unit, at least one of a first element associated with a user input application method of the target device or a second element associated with an information output method of the target device based on the determined disability type or the determined disability degree, the second element including a braille-based output element having a braille cell module provided in the target device;
obtaining, by the input unit, a user input to the target device through the first element of the target device; and
outputting, by the output unit, information corresponding to the user input through the second element of the target device, comprising:
converting the information provided from the target device into braille text, and
providing the braille text through the braille cell module.

2. The method of claim 1, wherein the first element comprises at least one of a touch-based input element, a voice-based input element, or an auxiliary means input element.

3. The method of claim 1, wherein the second element further comprises at least one of a visual output element and an auditory output element.

4. The method of claim 1, wherein the disability type comprises at least one of a visual impairment type, a hearing-impaired type, or a physical disability type.

5. The method of claim 1,
wherein the method further comprises controlling the target device to allow the user to access the braille cell module when the user is determined as being a blind user on the basis of the disability information.

6. (canceled)

7. The method of claim 4, wherein, when the disability type of the user is the hearing-impaired type, the outputting of the information corresponding to the user input comprises controlling a method of displaying sign language image information comprising information corresponding to the user input on the basis of user status information, which comprises at least one of position information, body information, or gaze information, which are associated with the user.

8. The method of claim 4, wherein, when the disability type of the user is the physical disability type, the obtaining of the user input comprises controlling a position and a driving method of the auxiliary means input element on the basis of user status information comprising at least one of position information, body information, or gaze information which are associated with the user.

9. An apparatus for providing customized interaction based on disability information, the apparatus comprising:
a user identification unit to obtain disability information comprising at least one of a disability type or a disability degree of a user, the user identification unit further configured to:
receive the disability information from a user terminal through a wireless communication;
receive a user input applied to a target device including an information terminal, or capture an image of the user;
determine the disability type or disability degree of the user based on the disability information obtained by storing the disability information from the user terminal, storing the user input applied to the target device, or analyzing image data obtained from the captured image of the user;
a component setting unit to set at least one of a first element associated with a user input application method of a target device or a second element associated with an information output method of the target device based on the determined disability type or the determined disability degree, the second element including a braille-based output element having a braille cell module provided in the target device;
an input unit to obtain a user input to the target device through the first element of the target device; and
an output unit to output information corresponding to the user input through the second element of the target device, the output unit further configured to convert the information provided from the target device into braille text, and provide the braille text through the braille cell module.

10. The apparatus of claim 9, wherein the first element comprises at least one of a touch-based input element, a voice-based input element, or an auxiliary means input element,
the second element further comprises at least one of a visual output element and an auditory output element, and
the disability type comprises at least one of a visual impairment type, a hearing-impaired type, or a physical disability type.

11. The apparatus of claim 9,
wherein the apparatus further comprises a module control unit configured to control the target device to allow the user to access the braille cell module when the user is determined as being a blind user on the basis of on the disability information.

12. (canceled)

13. The apparatus of claim 10, wherein, when the disability type of the user is the hearing-impaired type, the output unit controls a method of displaying sign language image information comprising information corresponding to the user input on the basis of user status information, which comprises at least one of position information, body information, or gaze information which are associated with the user.

14. The apparatus of claim 10, wherein, when the disability type of the user is the physical disability type, the input unit controls a position and a driving method of the auxiliary means input element on the basis of user status information comprising at least one of position information, body information, or gaze information which are associated with the user.

15. An information system that is customized based on disability information, the information system comprising:
a user terminal of a user:
a target device including an information terminal: and
an interaction providing apparatus configured to:
obtain disability information including a disability type and a disability degree of the user,
receive the disability information from a user terminal through a wireless communication,
receive a user input applied to a target device including an information terminal or capturing an image of the user,
determine the disability type or disability degree of the user based on the disability information obtained by storing the disability information from the user terminal, storing the user input applied to the target device, or analyzing image data obtained from the captured image of the user,
set at least one of a first element associated with a user input application method of a target device or a second element associated with an information output method of the target device based on the determined disability type or the determined disability degree, the second element including a braille-based output element having a braille cell module provided in the target device,
obtain a user input to the target device through the first element of the target device,
output information corresponding to the user input through of the target device,
convert the information provided from the target device into braille text, and
provide the braille text through the braille cell module.

16. The system of claim 15, wherein the first element comprises at least one of a touch-based input element, a voice-based input element, or an auxiliary means input element,
the second element further comprises at least one of a visual output element and an auditory output element, and
the disability type comprises at least one of a visual impairment type, a hearing-impaired type, or a physical disability type.

17. The system of claim 15,
wherein the interaction providing apparatus further comprises a module control unit configured to control the target device to allow the user to access the braille cell module when the user is determined as being a blind user on the basis of on the disability information.

18. (canceled)

19. The system of claim 16, wherein, when the disability type of the user is the hearing-impaired type, the interaction providing apparatus controls a method of displaying sign language image information comprising information corresponding to the user input on the basis of user status information, which comprises at least one of position information, body information, or gaze information which are associated with the user.

20. The system of claim 16, wherein, when the disability type of the user is the physical disability type, the interaction providing apparatus controls a position and a driving method of the auxiliary means input element on the basis of user status information comprising at least one of position information, body information, or gaze information which are associated with the user.
